(19) United States
(12) Patent Application Publication
(10) Pub. No.: US 2011/0148626 A1
(43) Pub. Date: Jun. 23, 2011

(54) GPS Device and Portal

(76) Inventor: William C. Acevedo, New York, NY (US)

(21) Appl. No.: 12/684,075

(22) Filed: Jan. 7, 2010

Related U.S. Application Data
(60) Provisional application No. 61/193,944, filed on Jan. 12, 2009.
(60) Provisional application No. 61/202,443, filed on Feb. 27, 2009.
(60) Provisional application No. 61/202,470, filed on Mar. 3, 2009.
(60) Provisional application No. 61/161,664, filed on Mar. 19, 2009.

(51) Int. Cl. G08B 1/08

(52) U.S. Cl. 340/539.13

(57) ABSTRACT

A portable GPS device and portal for communicating with the GPS device and methods of use thereof are described. A method of tracking movement of a portable GPS device using a geofence comprises: initializing a geofence, the geofence specifying a geographic boundary; storing parameters of the geofence in a portable GPS device; sending a notification message from the portable GPS device to a remote location in response to the portable GPS device determining that it has crossed the boundary.

This application claims the benefit of U.S. Provisional Application No. ______, filed Jan. 12, 2009, and entitled, “Portable GPS Tracking Device,” U.S. Provisional Application No. ______, filed Feb. 27, 2009, and entitled, “Portable Tracking Device Docking Stations,” U.S. Provisional Application No. ______, filed Mar. 3, 2009, and entitled, “Web Portal Method and System for Tracking and Managing GPS Devices,” and U.S. Provisional Application No. 61/161,664, filed Mar. 19, 2009, and entitled, “GPS System and Portal,” the entire contents of all of which are hereby incorporated by reference.

### FIELD OF THE INVENTION

The present invention relates to the field of portable global positioning satellite (GPS) devices and systems.

### BACKGROUND OF THE INVENTION

The Global Positioning System (GPS) is a navigation system developed by the U.S. Department of Defense. A number of satellites orbit the earth and continually transmit information that is received by portable GPS devices on earth. Each of the portable GPS devices uses information received from multiple satellites (typically three or four) in order to compute its position on earth. This is accomplished by the GPS device computing its distance to each of those satellites and determining where those distance measurements intersect based on known positions of the satellites.

Portable GPS devices are currently employed in vehicles, such as in automobiles and ships, or in handheld devices, as a navigational aid. Portable GPS devices are also employed to track the locations of persons, such as parolees under house arrest, and the locations of mobile objects so that the location of the object can be remotely determined.

### SUMMARY OF THE INVENTION

A portable GPS device and portal for communicating with the GPS device and methods of use thereof are described. In accordance with one embodiment of the present invention, a method of tracking movement of a portable GPS device using a geofence comprises: initializing a geofence, the geofence specifying a geographic boundary; storing parameters of the geofence in a portable GPS device; sending a notification message from the portable GPS device to a remote location in response to the portable UPS device determining that it has crossed the boundary.

### BRIEF DESCRIPTION OF THE DRAWINGS

The present invention is described with respect to particular exemplary embodiments thereof and reference is accordingly made to the drawings in which:

FIG. 1 illustrates a GPS system including a portable GPS device and portal in accordance with an embodiment of the present invention; and

FIGS. 2A-B illustrate communication flow in the system of FIG. 1 in accordance with an embodiment of the present invention.

### DETAILED DESCRIPTION OF THE INVENTION

A GPS system in accordance with the present invention comprises one or more portable GPS devices, a centralized processing center, referred to as a “portal,” that is user-accessible, and a communication medium that allows the portal to communicate with the portable GPS devices. As described in more detail herein, the present invention provides methods of using one or more of the portable GPS devices and the portal, such as for tracking the locations of movable objects. Through the use of the portal, a user can, among other things, track location of an object and set geographical limits for the object.

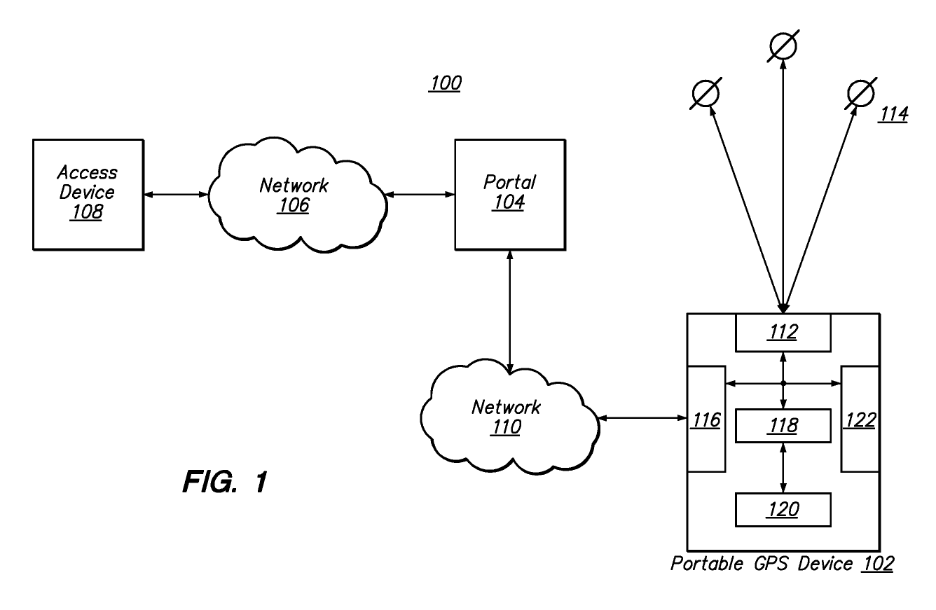

FIG. 1 illustrates a GPS system 100 including a portable GPS device 102 and a portal 104 in accordance with an embodiment of the present invention. The portal 104 includes at least a processor and a database. The portal 104 is accessible by users via a network 106, such as the Internet. The users may access the portal 104 using an access device 108 such as a personal computer, a cell phone equipped with a browser or other computing device. Once accessed, the user interacts with the portal 104 via a user interface. The portal 104 can be implemented as a secure, web-based network server having a data storage facility, such as one or more hard disks, and specially configured software stored within the server, e.g., on a hard disk and/or in memory. When executed, this software causes the portal 104 perform functions described herein.

A network 110, such as a cellular telephone network and/or the public switched telephone network (PSTN) allows the portal 104 to communicate with one or more of the portable GPS devices 102. Each portable GPS device 102 includes: a GPS receiver 112 for receiving location information from satellites 114 of the Global Navigation Satellite System (GNSS); a wireless modem 116 for sending and receiving two-way communications with the portal 104; a processor 118; data storage 120; and an on-board user interface (e.g. buttons, lights, vibrator, display screen, also referred to as a “dashboard”). The GPS device 102 includes specially configured software (e.g. stored in the data storage 120) that causes the GPS device 102 to perform the functions described herein. The GPS device 102 may also include an I/O port 122 that allows external devices to be directly connected to the GPS device 102.

The user interface on the portable GPS device 102 may include a status bar (i.e. a display) that displays pre-selected information. Subscriber can configure the interface to display information selected by the user. In this case, the selected information is preferably displayed first and other information is displayed next. The displayed information can include, for example, current time, current location, satellite signal strength, and wireless signal strength.

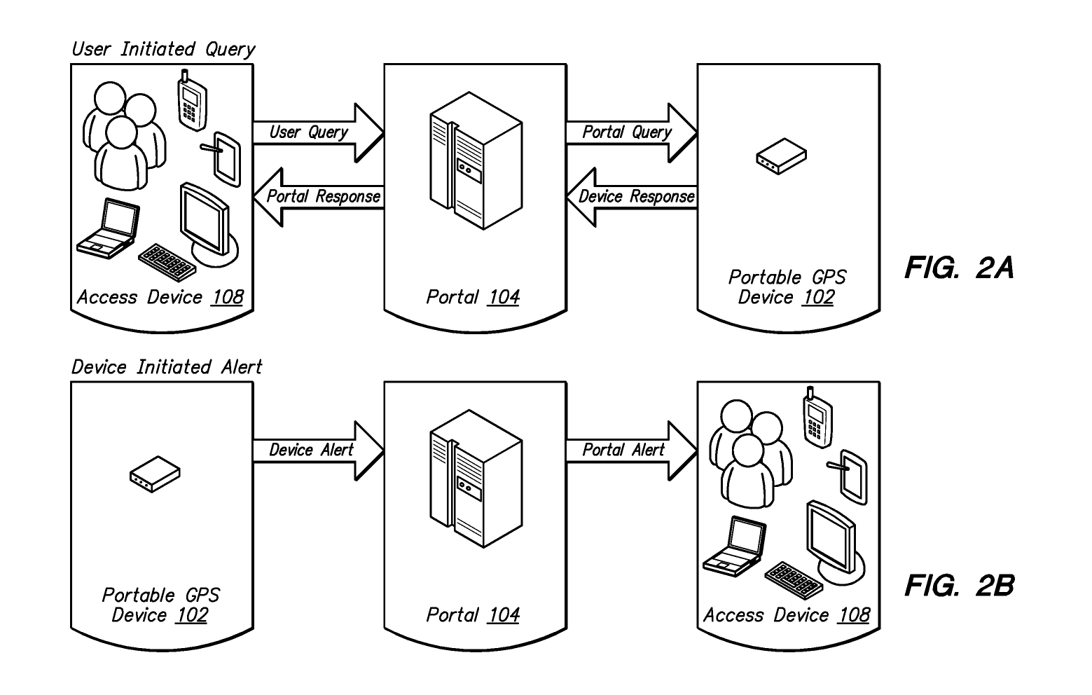

FIGS. 2A-B illustrate communication flow in the system of FIG. 1 in accordance with an embodiment of the present invention. As shown in FIG. 2A, a user may initiate a query to the portal 104 via an access device 108. For example, the user may wish to know the current location of a particular portable GPS device 102. In response to the user query, the portal 104 generates a query to the portable GPS device 102. In response to this portal query, the device 102 responds with an answer to the query. The portal 104 then receives the device response and, in turn, generates a response which it then sends to the access device 108. The access device 108 receives the portal response and provides information contained in the response to the user. In the example, the access device 108 informs the user of the location of the portable GPS device (e.g. by displaying the location on a map).

As shown in FIG. 2B, the portable GPS device 102 may initiate the sending of an alert to the user. For example, such an alert may be sent in response to the GPS device 102 entering a restricted area defined by a “geofence.” The device 102 first sends a device alert message to the portal 104. The device alert message can include information about the condition that caused the device 102 to the send the alert. In response to the device alert message, the portal 104 sends a portal alert message to an access device 108 specified by the user. This message can also include the information about the condition that caused the device 102 to initiate the alert. The access device 108 then informs the user of the alert by displaying information, sounding a particular alarm, or a combination thereof. For example, the portal 104 may send a text message to the user's cell phone that informs the user that the specified GPS device 102 penetrated the geofence.

In a preferred embodiment, the GPS system 100 is offered as a service to users who subscribe to the service. The user's may provide their own access devices 108, while the portal 104 remains under control of a service provider. The GPS devices 102 may be provided to the users by the service provider (for example, the GPS devices may be leased or sold to the users).

Geofencing

A geofence is a boundary defined by one or more coordinates on earth. For example, a geofence may be defined as the perimeter of a circle of a specified radius having its center at a specified location. As another example, a geofence may be defined by one or more line segments, each having a start and an end point.

For a particular geofence, information that defines the geofence boundary and other parameters for the geofence are stored within the portable GPS device 102. When the device 102 penetrates the boundary, this triggers an action on the device 102. For example, the device 102 may immediately send an alert to the portal 104 which then delivers the alert to a specified user's access device 108.

A geofence can be initialized by the user accessing the portal 104 using an access device 108. The user may then be presented with interface in the form of a series of web pages. The user may login to the portal using a user identification and password before being permitted to interact with the geofence functions of the portal 104.

For a particular portable GPS device 102 to be recognized by the portal 104, the device is registered with the portal 104. This can involve the user entering identifying information about the GPS device 102. For example, this may include a device name specified by the user, a device identification code and an activation code. The device identification code and the activation code may be provided to the user prior to the user registering the device 102 and may be used to verify that the device 102 is authorized for use by the GPS system service provider.

Once the user registers the GPS device 102 via the portal 104, a geofence can be established for the device 102. For example, the user can select one or more particular devices 102 for which the geofence is to be applied. The user can also select the parameters of the geofence. This can be accomplished, for example, by the user entering a street address or a longitude and latitude in order to specify the center of a circular geofence. The user may also enter a radius for the circular geofence.

The action that the device 102 will take in response to penetrating the boundary can be specified by the user selecting alert attributes to be applied to the particular geofence. These attributes may include whether the alert is sent upon the GPS device 102 entering an area defined by the geofence, upon the GPS leaving an area defined by the geofence or upon crossing the geofence boundary in either direction.

Speed and time elapsed can also be used to determine whether an alert is to be sent. The attribute of speed can be used, for example, such that if the speed of the GPS device 102 at the time of boundary crossing exceeds a defined setting, the action can be ignored. The time elapsed can be used, for example, such that an alert will be triggered only if the GPS device 102 remains inside or outside of the geofenced area for a selected amount of elapsed time.

The GPS device 102 can be configured so that a geofence violation will cause signal at an output on the device's I/O port 122. This allows the device 102 to initiate further action that provides enhanced security. This can include, for example, a disable circuit that disables the engine of a vehicle in which the UPS device 102 is located, visual or sounding devices or the triggering of existing security systems, such as a building alarm system.

The GPS device 102 preferably includes an ability to issue a warning that is perceptible in its immediate vicinity prior to, or instead of, sending an alert message. For example, a visible, audible or tactile stimulus, such as a flashing light, tone or vibration, can warn a person carrying the GPS device 102 that the device 102 is close to crossing a geofence or has crossed the geofence. The warning can increase in intensity (e.g. by increasing its cadence or magnitude) over a predetermined period of time (e.g. 30 seconds) unless the geofence violation is corrected (by returning to permitted area) within the time period. If the geofence violation is not corrected within the time period, an alert of the event is sent to the portal 104. Alternatively, the warning can commence when the device 102 is within a predetermined distance of the geofence (e.g. 100 feet) and can increase in intensity as the device gets closer to the geofence boundary. If the warning is ignored and the geofence is crossed, then an alert of the event is sent to the portal 104. In either case, this geofence warning feature is useful to warn a person carrying the GPS device 102 so as to provide an opportunity to take corrective action with respect to a geofence without any data be transmitted to the portal 104 unless corrective action is not taken. This feature can be used keep pets from leaving a specified area, by training the pet to respond to the vibration or tone warning, or for offender monitoring. This warning feature can be selectively enabled or disabled via the user interface of the portal 104. An advantage of this warning feature is that it minimizes data transmission from the GPS device 102 to the portal 104.

The GPS device 102 can include a motion sensor that can be used in conjunction with a geofence. For example, a geo fence can be initialized so that it has a very small radius. In addition, the user may configure the GPS device 102 so that its motion sensor is set to assist the geofence monitoring and to adjust the sensor's sensitivity. These settings can be made via the user interface of the portal 104. In this case, only a slight movement of the GPS device 102 from its specified position can result in the sending of an alert to the user.

A global geofence feature allows the GPS system 100 to configured such that geofence information stored at the device 102 is dependent upon the current location of the GPS device 102. In an embodiment, a user can initialize a global geofence via the portal 104. A global geofence is a geofence such that when specified conditions are met, the device 102 will request an updated list of one or more predetermined geofences based on the current geographical location of the device 102. A new global geofence is set that contains all of the geofences stored on the device 102 for its current location. The conditions under which the updated list is requested can include, for example, a specified geo fence boundary being breached by the device or the device 102 moving in a specified manner (e.g. when the device moves more than one mile from the location where it last updated the list). The global geofence may include at least one geofence, which when crossed, causes the portable device 102 to send a message to the portal requesting an update to the global geofence based on its current location, and one or more additional geofences which identify prohibited areas. When the device approaches such a prohibited area, the device 102 may issue a warning to the person carrying the device. Thus, the warning feature, discussed above, that warns a person carrying the device 102 that the device 102 is approaching a geofence can be active for all of the geofences included within the global geofence. And, as discussed above, the device 102 may issue an alert message to the portal if such a prohibited area is entered by the device 102.

Requesting an updated list of geofences from the portal 104 is advantageous because space required to store geofence information at the device 102 is limited.

For example, database of sex offender locations covering a large geographical area may have a very large number of entries. However, only a comparatively small number of sex offenders would be in the vicinity of the GPS device 102 at any one time. Therefore, geofences may be automatically initialized for the device 102 which are centered around the locations of sex-offenders that are within a specified distance of the current location of the device 102 (e.g. 5 miles). As the device 102 moves from this location, the geofences may be automatically updated to remove those that are centered outside the specified distance to the current location of the device 102 and to add any new ones that are inside the specified distance.

This feature creates a geofence that fully encompasses all existing geo-fences and, once triggered, will automatically update the device with the geo-fences that are now relevant to the current location of the device. This is ideal to notify person carrying the GPS device 102, or to notify another person via an access device 108, of dangerous, restricted or unauthorized areas, such as locations of sex-offenders, locations of swimming pools, locations of liquor stores, etc. Thus, the geofence database on the portable GPS device 102 can be periodically updated by loading a changed database to the device 102. Special geo-fences can be created in real-time depending upon current location of portable UPS device 102 and upon the density of nearby locations-to-be-avoided. This feature has an advantage of allowing the geofence(s) to be altered depending upon the location of the GPS device 102 and avoids having to store a significant amount of data at the device 102 which would be required for multiple the geofences.

Reminders, Scheduling, and Contact Management

In addition to registering one or more devices 102 as described above, users of the GPS system 100 can enter contact information for a number of other parties to which the user may wish to send alert notifications. For each such contact, the user can enter the contact's name or other identification, as well as one or more telephone numbers and email addresses. In a preferred embodiment, the number of contacts that the user can enter is unlimited.

In addition, for each contact, the user can specify circumstances under which the contact may be notified. For example, a selected contact can be notified each time any alert is issued by a particular device 102 or a selected contact can be notified each time a particular type of alert is issued by a particular device 102. Thus, each contact is not required to receive all alerts issued by the particular device 102. The type of alert can be individually selected for the specified contact and device 102 that is registered to a given user's account. Examples of alert types that can be specified are geofence violations, distress calls (also referred to as SOS calls) initiated by a person carrying a particular device 102, a scheduled tracking event or an overspeed alert. These types of alerts are discussed in more detail below.

As discussed above in connection with geofences, a user can set one or more geofences for a particular device 102 and be notified if the geofence is violated. In addition, for each geofence or for each device 102, the user can specify one or more contacts that will be notified of geofence violations.

A device 102 can be configured so that a person carrying the device 102 can initiate a distress call. For example, the device 102 may be equipped with a “panic” button. Once a distress call is initiated, the device 102 sends an alert message to the portal 104. The portal 104 then sends an alert message to contacts that are specified to receive this type of alert message initiated by that particular device 102. The user upon whose account the device 102 is registered can also receive any distress calls from the device 102.

Scheduled tracking events allows a user to set a tracking query based on date and time and location of a specified device 102. Scheduled tracking events are set up by the user via the interface to the portal 104. Information relating to the event is stored on the device 102 and on the portal 104. For example, the time and date of the event can be stored at the device 102 so that the device 102 will send its location to the portal 104 at the appropriate time. The time and date of the event can also be stored at the portal 104 so that the portal 104 can notify the user and/or specified contacts if the device 102 does not send its location to the portal 104 at the appropriate time.

Scheduled tracking events can be set to occur for a single instance or can be set to reoccur based on frequency parameters defined by the user. The parameters of an event can be specified in a variety of ways including date, days of the week or whether the event is recurring daily or weekly. In addition, a user can configure multiple scheduled tracking days and times for various different expected locations of the device 102.

A scheduled tracking event can be used, for example, to ensure that a person carrying the device 102 arrives at an expected destination at an expected date and time. Because the event is determined in advance, the user does not need to remember to request the information at that time or when a pattern of tracking is desired. An example of a scheduled tracking event is where the device 102 is carried by a child and the child is expected to leave school and arrive at home while the parent is still at work. At the expected time, the parent may receive a notification either confirming that the child did arrive at home or letting the parent know that the child did not arrive at home. If the child did not arrive at home, the parent, and perhaps another person such as a neighbor, may be informed of this and may also be informed of the current location of the child (e.g. by displaying a map with the current location of the device 102 being carried by the child identified on the map).

In addition, the device 102 can be configured to notify the person carrying it of the scheduled tracking event. For example, an audible notification or a vibration motor embedded in the device 102 may be activated. The device 102 may also display information relating to the tracking event, such as the location where the person is expected and the time that the person is expected at that location. This notification can occur prior to, and/or at the time of, the scheduled event and is useful for reminding the person carrying the device 102 that they are scheduled to arrive at a specified location. Whether and when this notification is to occur can be selected by the user at the time the scheduled tracking event is set up via the user interface to the portal 104 or by the person carrying the device 102 through its dashboard interface.

Schedules of tracking events, reminders of particular events and details of alert notifications issued as a result of a scheduled tracking event can be transmitted to any specified contact party or to a tracked device 102 through the interface to the portal 104. The user can control which contacts receive which information or alerts so as to protect privacy.

Notifications of scheduled tracking events can be sent to a specified contact, for example, by the portal 104 initiating a telephone call to the contact's telephone number and playing a pre-recorded message. The user may record the message at the time of setting up the scheduled tracking event or may select from a plurality of pre-recorded messages stored at the portal 104. Alternatively, or in addition to the pre-recorded message, the portal 104 may send a predetermined email or text message to the contact using the contact's email address or telephone number. Similarly, the user may type the message at the time of setting up the scheduled tracking event or may select from a plurality of pre-determined messages stored at the portal 104.

In addition to storing email or telephone numbers for contacts, the user may also enter street addresses for the contacts. In this case, the contacts' street addresses can be identified on a tracking map that is displayed for the user by the access device 108. For example, when the user requests that the location of a device 102 registered for the user be displayed, the contact locations in the vicinity of the device 102 can also be displayed. Thus, a number of contacts can be entered for map legend reference points without sending any data to the contacts. Preferably, there is not a limit to the number of contacts that can be entered for this purpose.

In addition to the scheduled tracking events described above, the user may schedule reminder events that are independent of the location of any device 102. For example, the user can send reminder notifications to contacts or to a specified portable GPS device 102. Reminders can be transmitted to any contact party or a tracking device through the web based portal. Examples include a reminder of a wedding anniversary to be sent to a specified contact, or a reminder of a time to take medications to be sent to a specified portable device 102. Other examples include a reminder of a curfew, holiday or other event.

In an embodiment, the user can prevent the device 102 from being disabled by the person carrying the device 102. This device disable-prevention feature can be activated by the user via the user interface to the portal 104. As an example of this feature, the device 102 may be equipped with a mechanical power switch. When the device disable-prevention feature is active, the mechanical power switch may appear to function as expected the person carrying the device 102 by disabling outward signs of the device 102 being powered-on, such as by shutting off LED's and ceasing any sound or vibration notifications. This gives the appearance of the device 102 being powered off. However, the device 102 continues to maintain full communicative operation with the portal 104, e.g., by sending alert messages to the portal 104 and by responding to location inquiries from the portal 104. In an embodiment, an attempt to turn the device 102 off by its mechanical power switch causes the device 102 to send a notification to the portal 104 which then notifies the user of the attempt. This feature is expected to be particularly useful in the event of theft of the device 102. When the device disable-prevention feature is inactive, the mechanical power switch functions to power-off the device 102. In an embodiment, when the user activates the disable-prevention feature while the device 102 is powered-off, this causes the device 102 to power-on but without showing outward signs of being powered-on. This allows the device 102 to be powered-on without the person carrying the device 102 becoming aware that the device 102 has been powered on.

Location Query and Confirmation

In accordance with an embodiment of the invention, a user can issue a query to any portable GPS device 102 registered to that user in order to determine the current location of the device 102. For example, the user can issue such a query by accessing the portal 104 using an access device 108. In response to such a query, the current location of the device 102 may then be provided to the user. For example, the location of the device 102 may be displayed for the user on a map. Alternatively, a street intersection or address nearest to the location of the device 102 may be displayed.

In an embodiment, such a location query can be initiated by the user from any telephone. For example, the user may dial a specified telephone number and be prompted to enter a user identification and passcode. The user may then be prompted to identify the specific device 102 for which the location information is desired. This information may be forwarded to the portal 104 which then determines the location of the device 102 and returns this information to the user. The user may then be provided with an automated voice indication of the current location of the device 102. For example, an automated voice may provide a nearest street intersection or address where the device 102 is currently located.

In addition to the user being able to request the current location of the device 102, specified persons from the user's contact list may be able to issue such a request. For example, the user may provide such persons with a unique user identification and passcode which that person can use to access the portal 104 (using an access device 108 or any telephone as described above) to issue such a location query.

In addition to providing the location information to the user, the portable GPS device 102 can also be configured to notify the person carrying the device 102 that a location query was made by a remote party. Notification of that query may be made by activating a vibration motor in the device 102, or by a visual indicator (e.g. LEDs on the device 102). An example of an application for this feature would be tracking a child who is late for dinner and reminding them they are late while also receiving their location.

SOS Confirmation

In accordance with an embodiment of the invention, a person carrying a portable GPS device 102 can initiate a “panic” or “SOS” alert to the user upon whose account the device 102 is registered and/or to specified persons on a contact list. For example, the user can configure this SOS function via the portal 104 so that the user and/or any specified persons in the user's contact list receives any such SOS alerts.

The SOS alert can be triggered by the person carrying the device 102 pressing a “panic” button on the device 102. In response, the device 102 sends an SOS alert message to the portal 104. The portal 104 then forwards a portal SOS alert message to all of the intended recipients. These parties receive the SOS notification from the portal 104 together with a request to confirm receipt of the SOS notification. Each of the notified parties may then reply that they received the SOS notification by pressing a specified button or entering a specified confirmation code into their access device 108 (e.g. the notification may contain this confirmation code).

Upon receiving confirmation from one of the intended recipients, the acknowledgment is forwarded to the device 102 that initiated the SOS request. This confirmation may be received, e.g., as a vibration sequence, LED pattern or both, as selected via the user interface to the portal 104. Thus, upon at least one of the notified parties replying to the portal 104, the portal 104 will then notify the person carrying the device 102 (i.e. the person who initiated the SOS alert), that the alert was confirmed. If no confirmation has been received, the portal 104 will continue resending the SOS alert messages until a response is returned. This SOS confirmation feature is especially useful because it allows the person who initiated an SOS alert to know whether anyone received the notification.

As an example of operation of the system 100 during an SOS alert notification, a child carrying a portable GPS device 102 presses its panic button. Then, the portable GPS device may then confirm to the child that the SOS message was sent to the child's guardian (e.g. the device 102 vibrates). The child's guardian receives the SOS notification, and is prompted to reply that message was received. The portable device 102 informs the child that message was acknowledged by guardian. The child may also be prompted to confirm that the child received the confirmation that the message was sent or to confirm that the child received the confirmation that the message was received by the guardian.

In an embodiment, the portal 104 will also require a confirmation of the SOS alert if the user's account is logged into while an active SOS alert is awaiting confirmation.

The portal 104 can preferably be configured so that each SOS alert notification is sent to a specified group of one or more contacts and/or access devices 108 that are registered to a given user's account. These groups are referred to these as notification sets. When an SOS alert message is received by the portal 104 from a particular portable GPS device 102, the portal 104 compares information contained in the message, such as the identification of the particular device 102, its location and/or time of day it was received, to the notification sets configured by the user whose account the device 102 is registered. Based on this comparison, the portal 104 relays the SOS alert notification to the appropriate notification set.

In this manner, each SOS notification can be routed based implicit attributes (e.g. the time of day or the day of the week it is received) or explicit attributes (e.g. identification of the sending device 102). For example, a user may define a notification set as a “Group Emergency Services” which is to receive all SOS requests except not SOS requests initiated from a specific device 102. Notification sets can be defined for each device 102 individually or multiple devices 102 may have a shared notification set. In addition, contacts preferably have the ability to select single or multiple ways of notification based on device and alert or notification type. For example, a defined contact can receive an SOS request via SMS, but all others via Email or in any manner preferred by the contact.

Contact I/O Port

In accordance with an embodiment of the present invention, a portable GPS device 102 is equipped with an I/O port 122 that allows external devices to be directly connected to the GPS device 102. In a preferred embodiment, the I/O port 122 comprises a locking, 18-pin, multi-I/O connector. Within the device 102, appropriate support circuitry provides functions, such as serial communications, buffering, analog-to-digital and digital-to-analog signal conversion, transient voltage surge suppression (TVSS), contact closure, reverse polarity protection, and so forth. Functionality available at the pins of the I/O connector can include DC supply provision to external devices, DC battery charging for the device 102, voltage level detection (via analog-to-digital conversion), high or low logic signaling, open or closed dry contacts, serial data communications (e.g. via low speed RS-232 protocol).

One or more external devices an be connected to the I/O port 112 and can be controlled by the GPS device 102 or can provide input to the GPS device. For example, solid-state or mechanical switches can be included within the portable GPS device 102, which when activated, can control a connected external device by triggering a loop circuit that can be either open or closed. The device 102 can be directed to open or close the loop via the portal 104 or via an SMS message. In addition, the device 102 can be configured (e.g. via the portal 104) to open or close the loop upon specified conditions. For example, the device 102 can be attached to portable machinery and can be configured to disable the machinery if the machinery is operated or moved in a manner that is not authorized (e.g. it violates a specified geo-fence). Thus, a geo-fence violation can trigger an output on the device 102 I/O port 122 to initiate further action and provide enhanced security. As another example, a portable GPS device 102 may be attached to a valuable object such as a painting while the I/O port can be connected to an alarm system for the building in which the object is located; in this way, the building alarm system can be activated and the building secured if the object is moved. External devices can include but is not limited to disable circuits, visual or sounding devices or triggering of existing security systems.

In addition, the portable GPS device 102, can receive information from an external device which then causes the device 102 to send an alert message to the portal 104. For example, the device 102 can be attached to the ignition circuit of powered machinery and can be configured to send an alert message to the portal 104 when the machinery is powered-on. This feature can be utilized to interface the device 102 to various external devices to provide enhanced protection, safety and security. This feature is especially useful in embedded implementations, in which the device 102 is attached to another object, in order to enhance the security capabilities of the device 102 by detecting movement of the device 102, movement of an object protected by the device 102 or movement of an object near the device 102. For example, this feature can be used to notify a user of the unwanted removal of the device 102, such as to notify a equipment owner of the unauthorized removal of the device 102 from that equipment. As another example, a portable GPS device 102 may be carried by a fireman, in which case, a temperature sensor may be included in the device or coupled to the device 102 via the port 122. Accessories that can be attached to the device 102 include a “man-down” pull-to-trigger, a bullet-proof vest notification of impact, a leash connected to property to be protected or to an entry way door, a magnetic sensor connected to detect opening of an entryway door and tethers to indicate whether a person or property is moved or dislodged.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A method of tracking movement of a portable GPS device using a geofence comprising steps of:
initializing a geofence, the geofence specifying a geographic boundary;
storing parameters of the geofence in a portable GPS device;
sending a notification message from the portable GPS device to a remote location in response to the portable GPS device determining that it has crossed the boundary.

2. The method according to claim 1, wherein said initializing is performed by a user accessing a web portal, the web portal comprising at least a processor and a database and the web portal being in communicative contact with the portable GPS device.

3. The method according to claim 2, wherein said storing the parameters of the geofence in the portable GPS device comprises sending the parameters of the geofence from the web portal to the portable GPS device.

4. The method according to claim 2, wherein the web portal receives the message and wherein, in response to the message, the web portal notifies the user that the portable GPS device has crossed the boundary.

5. The method according to claim 1, wherein the notification message is sent only after the portable GPS device has crossed the geofence boundary without returning across the boundary for at least a predetermined period of time.

6. The method according to claim 5, wherein the portable GPS device issues a warning prior to sending the message.

7. The method according to claim 6, wherein the warning comprises a visible, audible or tactile stimulus.

8. The method according to claim 1, wherein the portable GPS device issues a warning prior to sending the message and wherein the warning is issued in response to the portable GPS device approaching the geofence boundary.

9. The method according to claim 8, wherein the warning comprises a visible, audible or tactile stimulus.

10. The method according to claim 9, wherein intensity of the stimulus increases as the portable GPS moves closer to the boundary.

11. The method according to claim 1, further comprising, in response to the message, storing at least one additional geofence in the portable device.

12. The method according to claim 11, wherein the at least one additional geofence is selected from a group of geofences according to a current location of the GPS device.

13. The method according to claim 12, wherein said storing at least one additional geofence in the portable GPS device is performed by a web portal sending parameters of the at least one additional geofence to the portable GPS device, the web portal comprising at least a processor and a database and the web portal being in communicative contact with the portable GPS device.

14. A method of tracking movement of a portable GPS device using a geofence comprising steps of:
initializing a global geofence, the global geofence comprising a plurality of geofences, each geofence specifying a geographic boundary;
storing parameters of the global geofence in the portable GPS device; and
sending a notification message from the portable GPS device to a remote location in response to the portable GPS device determining that it has crossed a boundary associated with the global geofence.

15. The method according to claim 14, further comprising, in response to the message, updating the stored parameters in the portable GPS device with parameters for at least one additional geofence.

16. The method according to claim 15, wherein the at least one additional geofence is selected from a group of geofences according to a current location of the GPS device.

17. The method according to claim 15, wherein said updating the stored parameters is performed by a web portal sending the parameters of the at least one additional geofence to the portable GPS device, the web portal comprising at least a processor and a database and the web portal being in communicative contact with the portable GPS device.

18. The method according to claim 15, wherein the portable GPS device issues a warning in response to the GPS device approaching a second boundary associated with the global geofence.

19. The method according to claim 18, wherein the warning comprises a visible, audible or tactile stimulus.

20. The method according to claim 19, wherein intensity of the stimulus increases as the portable GPS moves closer to the second boundary.
